(19) United States
(12) Patent Application Publication
(10) Pub. No.: US 2009/0019982 A1
(43) Pub. Date: Jan. 22, 2009

(54) Cutting Tool for Hobbyists

(76) Inventor: Michael Sabolesky, Salem, CT (US)

Correspondence Address: Attorney Bruce W. Tedeschi, Rakosky, Haviland & Tedeschi, PC,, 71 Granite St., PO Box 1190, New London, CT, 06320, US

(21) Appl. No.: 12/175,581

(22) Filed: Jul. 18, 2008

Related U.S. Application Data
(60) Provisional application No. 60/961,088, filed on Jul. 19, 2007.

(51) Int. Cl. B26D 1/24; B26D 1/15

(52) U.S. Cl. 83/500; 30/304

(57) ABSTRACT

An improved cutting device that is specifically organized to efficiently line up and completely cut planks of lightweight wood and other materials, particularly materials important to RC modelers. More specifically, the invention comprises two rotary blades that are partially overlapped thereby providing for a cutting means while also providing for stability and preventing the lightweight material from moving along other planes (e.g. side-to-side, up-down) at the cutting surface.

### PRIOR APPLICATION

This Application claims priority from provisional application Ser. No. 60/961,088 filed on Jul. 19, 2007.

### FIELD OF THE INVENTION

The present invention relates to a cutting device and woodworking machine for hobbyists, such as RC Modelers.

### BACKGROUND

The present invention relates to an improved cutting apparatus that is specifically organized to efficiently line up and completely cut planks of lightweight wood and other materials, particularly materials important to RC modelers. More specifically, the invention comprises two rotary blades (Fiskar type, for example) that are partially overlapped for a complete cut of the material without anomalous movement of the material. Such anomalous movement can include side-to-side and up-down of the material relative to the cutting device. This problem is particularly acute for lightweight hobbyist materials such as balsa wood, styrofoam, etc. The present invention discloses a cutting means comprised of two rotary blades that are juxtaposed to each other with a slight overlap. This positioning of the rotary blades provides not only a cutting function but also prevents the material from moving side-to-side or up-down at the place of the cut during the cutting process. Thus, the invention allows the cutting of long planks of lightweight material to be made easily. The apparatus for lining up planks and cutting can be made small and portable for modelers and other craftsman.

The prior art discloses devices that utilize juxtaposed rotary blades for cutting, but the art does not reveal the features and elements that allow the advantages of cutting lightweight materials, such as are necessary when working with model kit materials, e.g. balsa wood and styrofoam. For example, various overlapping rotary cutting apparatus have been invented but none have been specifically designed to function as model kit cutters with the attendant advantages of this invention.

### SUMMARY OF THE INVENTION

It is therefore an object of the invention to disclose a rotary cutting device for working with lightweight materials.

It is another object of the invention to disclose an apparatus, used in conjunction with the rotary blades, that would allow the tracking of lightweight planks up to the rotary blades.

It is another object of the invention to disclose an apparatus that is adapted to be small, safe and portable for any craftsman working with lightweight materials.

It is to be understood that both the foregoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a front view illustrating an overview of the cutting apparatus in accordance with an exemplary embodiment of the present invention:

FIG. 2 is a side view of the fence and fence guide used to position the material as it moves into place for cutting by the rotary blades;

### DETAILED DESCRIPTION OF THE INVENTION

Although the preferred embodiments of this invention have been described in detail by way of illustration for purposes of understanding the device, it is understood that various modifications and changes may be made within the scope of the following claims without departing from the essence and material advantages of the invention.

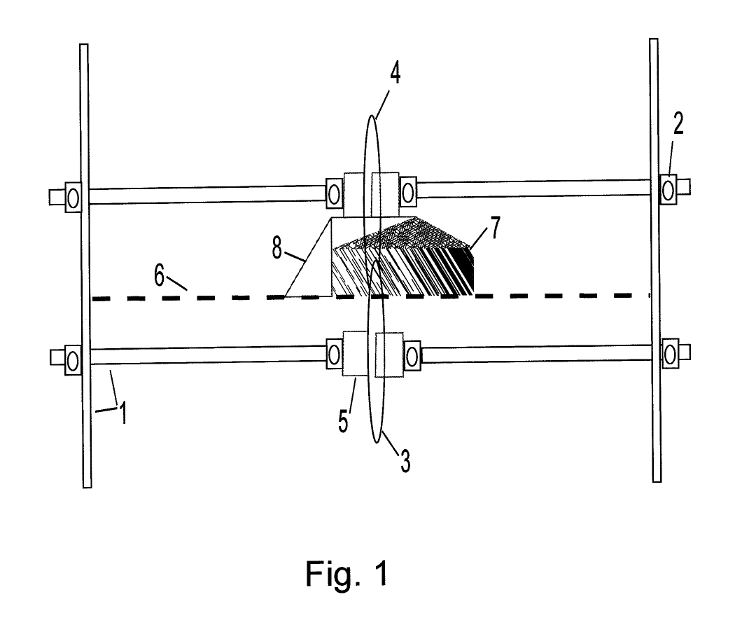

With reference to the frontal view in FIG. 1, two Fiskar type rotary blades (3,4) are held in place by collars (2) and spacers (5) attached to metal rods (1). The blades are optimally 28 mm but may be larger for thicker materials. The blades are positioned such that they slightly overlap as shown, but the blades do not contact side-to-side and, thus, each can freely rotate around their own horizontal axes during the cutting process. This organization of the blades provides optimal cutting of the material (7) while keeping the lightweight material from rising up. The material is preferably balsa wood, but other materials used by hobbyists, such as Styrofoam, can also be used. An optional fence guide (8) can be used to keep the plank material correctly oriented perpendicular to the cutting face.

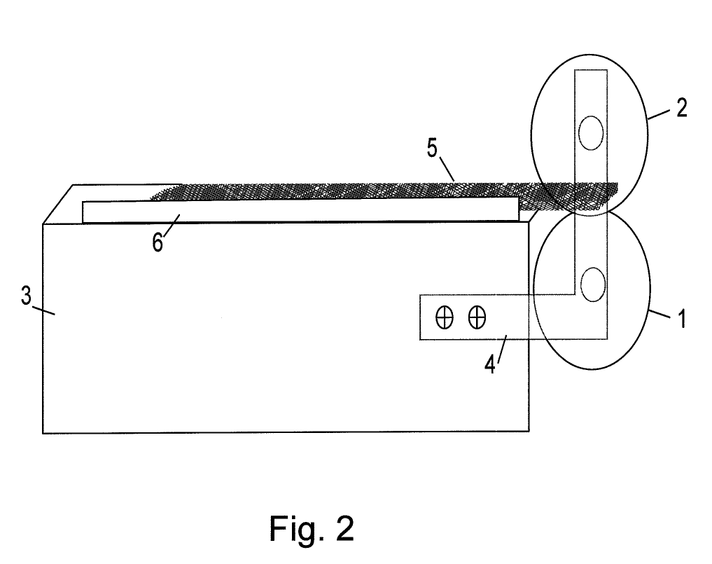

With reference to the side view in FIG. 2, the metal rods holding the blades (1,2) in place are attached via corner braces (4, showing one brace) to a wooden block (3). The plank material (5) can then be pushed across the top surface of the wooden block for cutting by the rotary blades. The use of a fence guide (6) provides stability of the plank in a horizontal (left-right) direction while the blades themselves prevent movement of the plank in a vertical (up-down direction).

I claim:

1. A rotary cutting device for cutting lightweight materials comprising:
a. two rotary blades, each vertically positioned relative to a horizontal cutting plane and oriented, relative to each other, side-by-side with one blade somewhat above the other such that there is a slight overlap at their cutting edges, and wherein each blade is held in place at the center of the blade by a horizontal rod such that each blade is free to rotate around its horizontal axis during a cutting process and
b. a horizontal surface for moving material, to be cut, across and through the rotary blades.

2. A rotary cutting device according to claim 1 wherein each blade is 28 mm in diameter.

3. A rotary cutting device according to claim 1 further comprising a lateral array of more than one rotary blade pair such that multiple cuts can be made in a material during a single pass of the material across and through the lateral array of paired rotary blades.

4. A rotary cutting device according to claim 1 wherein the material is balsa wood or Styrofoam.

5. A rotary cutting device according to claim 1 further comprising a fence guide to restrict the position of the material to a plane perpendicular to the rotary blades as the material is pushed across and through the rotary blades.
